(19) United States
(12) Patent Application Publication
(10) Pub. No.: US 2004/0027014 A1
(43) Pub. Date: Feb. 12, 2004

(54) Electronically commutated direct current motor

(76) Inventors: Thomas Weigold, Baden-Baden (DE); Johannes Pfetzer, Buehl (DE); Guenter Riehl, Buehl (DE); Matthias Schmitz, Gifhorn (DE); Gerta Rocklage-Marliani, Bochum (DE); Thorsten Heiderich, Vaihingen/Enz (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/311,848

(22) PCT Filed: Jan. 25, 2002
(86) PCT No.: PCT/DE02/00246

(30) Foreign Application Priority Data
Apr. 20, 2001 (DE) 101 19 404.8

(51) Int. Cl. H02K 11/00

(52) U.S. Cl. 310/68 R

(57) ABSTRACT

In an electronically commutated direct-current motor having a stator (14) with a multi-phase stator winding (15) and a housing (11) receiving the stator (14), having a commutation device (21), disposed in the housing (11) for consistent connection of the winding phases to a direct voltage from the electrical system, which has a plurality of semiconductor switches (22) and an electronic control unit (26), received by a printed circuit board (24), for triggering the semiconductor switches (22), and having a connection plug (13) for delivering the direct voltage from the electrical system, in order to provide a more-robust embodiment of the commutation device (21), all the electronic components of the commutation device (21) that carry power currents, such as the connection plug (13), semiconductor switches (22), electrolyte capacitor (25), and so forth, are contacted on a stamped grid (23), with which the electrical connection with the stator winding (15) and the printed circuit board (24) is established. The stamped grid (23) is embedded in an insulator body (46) and serves as a substrate for the semiconductor switches (22) and the printed circuit board (24)

### PRIOR ART

The invention is based on an electronically commutated direct-current motor as generically defined by the preamble to claim 1.

In electronically commutated direct-current motors, known as EC motors and also called brushless drive motors, the semiconductor switches required for the electronic commutation, in the form of power transistors, and the electronic control unit for consistent triggering of the power transistors, are integrated into the motor itself.

To that end, in a known EC motor embodied as an external rotor motor (German Patent Disclosure DE 41 22 529 A1), the stator is secured to a bowl-shaped housing engaging the rotor on the outside and surrounding it, and whose outer bottom, remote from the rotor, an axially protruding annular wall is formed on, which together with a plastic cap snapped onto the annular wall forms a closed receiving chamber. In the receiving chamber, both the power transistors and a printed circuit board that carries the electronic control unit are disposed. Via the conductor tracks of the printed circuit board, on the one hand the control line to the control grids of the power transistors is established, and on the other, the connection plug inserted into a recess in the annular wall is contacted. The power transistors are divided into two groups, each of three power transistors, and rest with their cooling faces on protrusions on the bottom of the receiving chamber. The approximately annular printed circuit board also rests on the protrusions, and in the regions of the two groups of power transistors it has recesses. The printed circuit board is prestressed at multiple points against the protrusions on the bottom, with the aid of fastening screws. Two brackets are held together with the fastening screws on the bottom and fit over the three associates power transistors in one go. Between the inside of each bracket and the power transistors, there is a prestressed leaf spring, which presses the power transistors firmly against the protrusions on the bottom and in this way assures especially good heat dissipation from the power transistors to the housing.

### ADVANTAGES OF THE INVENTION

The direct-current motor of the invention, having the characteristics of claim 1, has the advantage that all the power currents are carried via the stamped grid, and the printed circuit board, with its conductor tracks that are vulnerable to being soldered on, is now used only for the weak signalling and control currents and for supplying power to the electronic control unit. The stamped grid, which is embedded in an insulator body that is produced for instance by spray-coating the stamped grid with plastic, is mechanically so stable that it can be used for still other functions besides purely carrying power current, such as for fixing the semiconductor switches and other power components, such as electrolyte capacitors and chokes, for pressing the housings of the semiconductor switches against cooling faces, and for fixing the assembly unit, formed by it together with the printed circuit board, in the motor housing.

By the provisions recited in the other claims, advantageous refinements of and improvements to the direct-current motor defined by claim 1 are possible.

In one advantageous embodiment of the invention, for contacting the winding phases, insulation displacement contacts are embodied on the stamped grid in such a way that they establish electrical contact points with the associated winding phases upon the insertion of the stamped grid into the motor housing and keep them in the final position of the stamped grid. By this structural provision, contact points are advantageously produced without solder, and such expensive additional processes as soldering or welding can be omitted. In the joining operation, the insulation displacement contacts peel off the insulating paint on the winding wire at the ends of the winding phases and make a good connection between the winding phases, the stamped grid, and the semiconductor switches. In this way, there is only a single connecting point between the stator and the commutation device of the brushless electric motor, which is very simple to join and does not require any thermal connection process.

In an advantageous embodiment of the invention, the stamped grid is divided into one upper and one lower, separate grid layer, which are disposed in planes parallel to one another in spaced-apart fashion and are held together by the insulator body. This construction makes a compact embodiment of the stamped grid, with small dimensions in the radial direction, possible. Advantageously, each grid layer of the stamped grid is assigned one plug pin of the connection plug, for application of the positive and negative potential of the direct voltage from the electrical system.

### DRAWING

The invention is described in further detail below in terms of an exemplary embodiment shown in the drawing. Shown are:

FIG. 1, a longitudinal section through an electronically commutated direct-current motor;

FIG. 2, an electrical circuit diagram for the direct-current motor of FIG. 1;

FIG. 3, a perspective view in the direction of the arrow III in FIG. 1 of the direct-current motor, with the housing cap removed;

FIG. 4, a perspective back view of a stamped grid, embedded in an insulator body, in the direct-current motor of FIG. 1, without the electronic components of a commutation device;

FIG. 5, a plan view on the upper grid layer of the stamped grid of FIG. 4;

FIG. 6, a plan view on the lower grid layer of the stamped grid of FIG. 4;

FIG. 7, a plan view on the grid layers, one above the other in the axial direction, of the stamped grid of FIGS. 4 and 5, with the assembly of the electronic components of the commutation device.

### DESCRIPTION OF THE EXEMPLARY EMBODIMENT

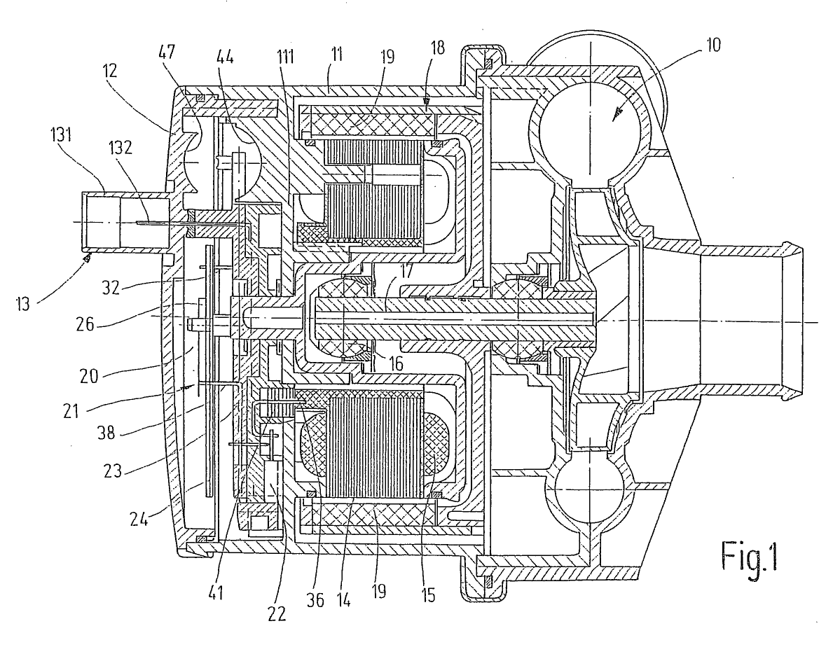

The electronically commutated direct-current motor shown in longitudinal section in FIG. 1 and hereinafter called EC motor for short, is used in motor vehicles to drive such devices as, in this case, a coolant pump for the coolant of the vehicle engine. The EC motor embodied as an external rotor motor has a motor housing 11, to one face end of which the coolant pump 10 is flanged, and whose other face end is covered by a removal housing cap 12. A connection plug 13 for connecting the EC motor to the 12-Volt direct-voltage system of the motor vehicle is integrated with the housing cap 12; its plug housing 131 is embodied integrally with the housing cap 12, and in the exemplary embodiment it includes a total of four plug pins 132. A stator 14 is fixed in the motor housing 11 and carries a multi-phase stator winding 15. On the side remote from the housing cap 12, the stator is secured to a housing bottom 111 penetrating the motor housing 11 transversely, and in a hollow-cylindrical inner chamber it carries a bearing 16 for receiving a rotor shaft 17, which protrudes into the coolant pump 10, where it is additionally supported and receives the pump wheel in a manner fixed against relative rotation. A permanent-magnet-excited, cup-shaped rotor 18 is retained in a manner fixed against relative rotation on the rotor shaft 17, and with its cup jacket it fits over the stator 14. Permanent magnet segments 19 are disposed on the inside of the cup jacket.

A receiving chamber 20 is embodied on the side of the housing bottom 111 remote from the stator 14; it is closed on one side by the housing bottom 111 and on the other by the housing cap 12. A commutation device 21 for the EC motor is received in the receiving chamber 21; in a known manner, this device includes semiconductor switches 22, embodied as MOSFETs, an electronic control unit 26 for triggering the semiconductor switches 22, an electrolyte capacitor 25, and optionally interference-suppression chokes. The commutation device 21 is accommodated on a structural unit that comprises a stamped grid 23, embedded in a plastic insulator body 46, and a printed circuit board 24, disposed parallel to and spaced apart from the stamped grid 23 and secured to the embedded stamped grid 23, the latter having conductor tracks 241 represented by dashed lines in FIG. 1; the allocation of the electronic components of the commutation device 21 to the stamped grid 23 and the printed circuit board 24 is done in such a way that the power electronics are associated with the stamped grid 23, while the electronic control unit 26 is associated with the printed circuit board 24. The insulator body 46 is produced by spray-coating the stamped grid 23 with plastic.

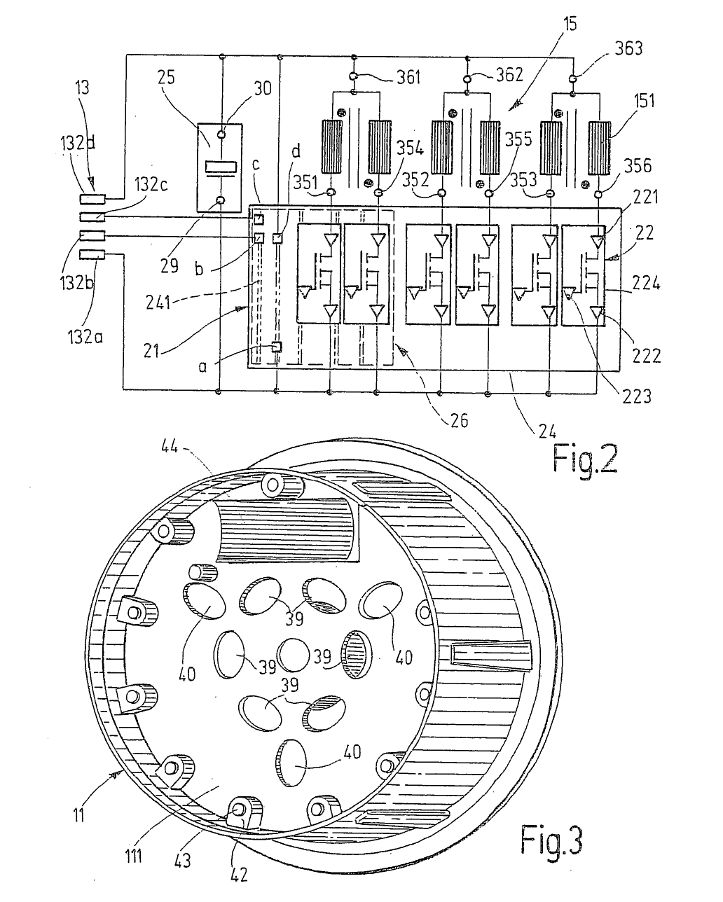

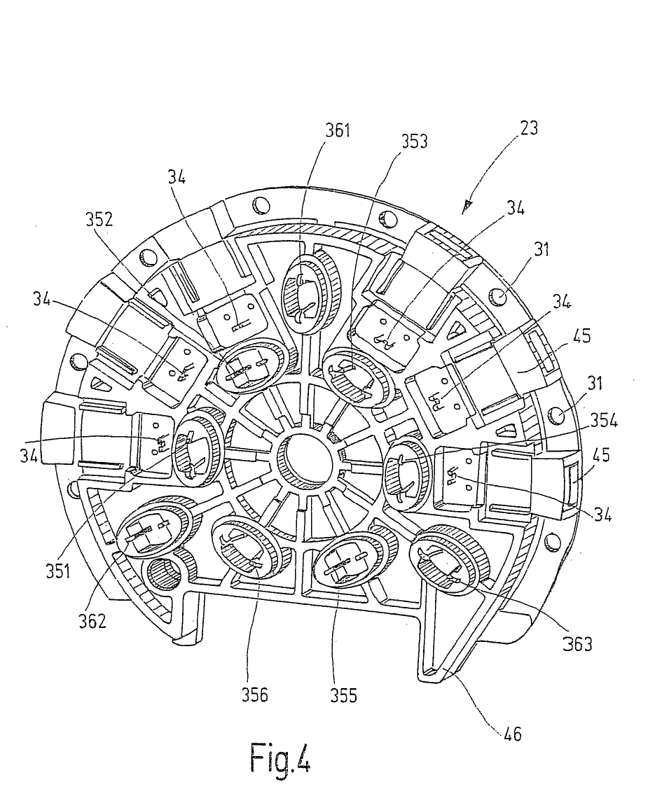

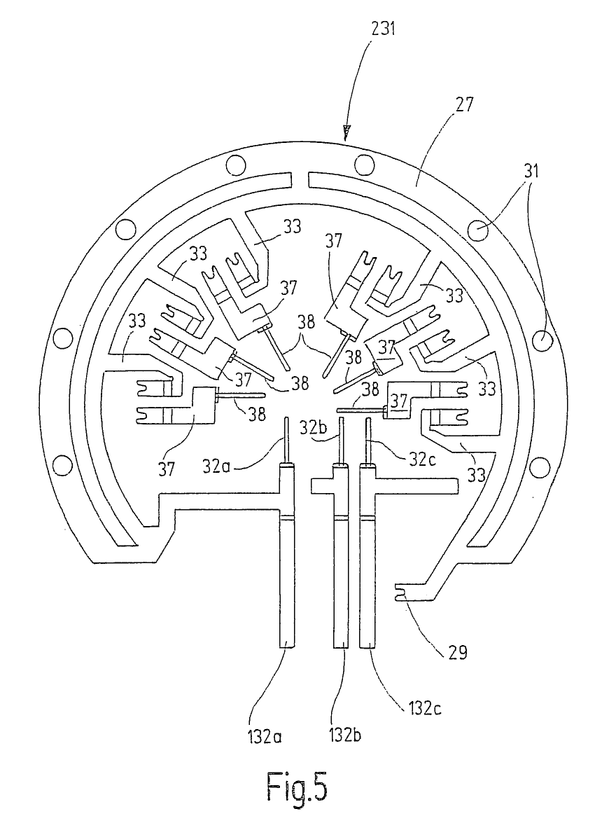

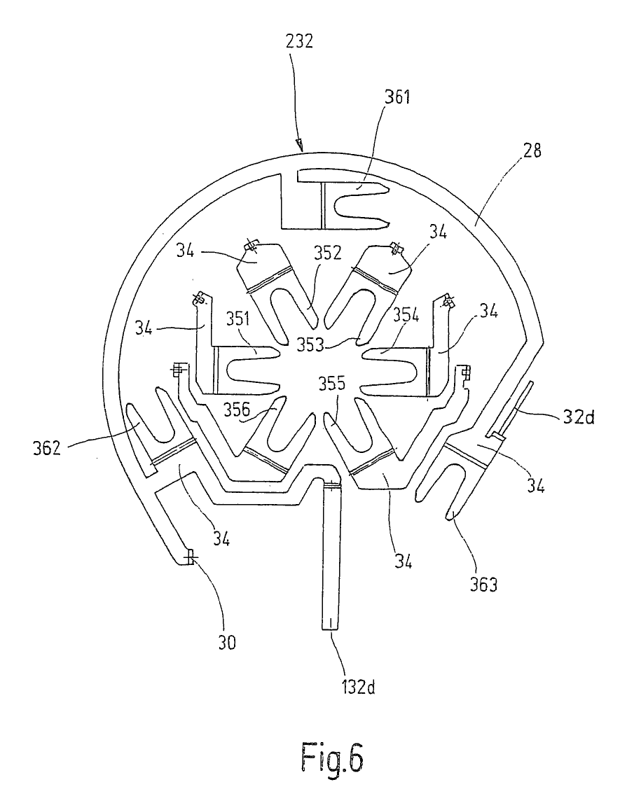

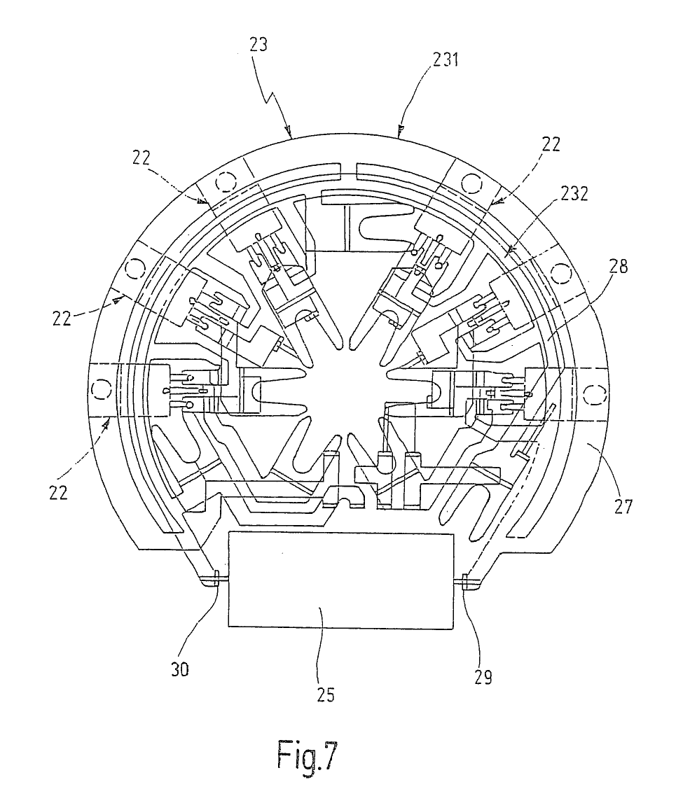

In the exemplary embodiment of the EC motor with a six-phase, three-strand stator winding 15, whose electrical circuit diagram is shown in FIG. 2, the commutation device 21 includes six semiconductor switches 22, embodied as low-side MOSFETs, of which each one is disposed in series with a winding phase 151 of the stator winding 15. The semiconductor switches 22 are connected by their control terminals 221, 222, or in the case of MOSFETs their drains 221 and sources 222, to the winding ends of the winding phases 151, and to the negative or ground potential of the direct-voltage system. The control electrodes 223 of the semiconductor switches 22, or in the version as MOSFETs the gates 223, are connected to the electronic control unit 26 of the commutation device 21, which triggers the semiconductor switches 22 consistently such that the individual winding phases 151 are connected successively to the direct-voltage system. The electronic control unit 26, which in FIG. 2 is disposed on the back side of the printed circuit board 24, is represented here only schematically by dashed lines. The plastic-sheathed stamped grid 23 is shown in FIG. 4; the stamped grid 232 without the plastic sheathing but equipped with the electronic components of the commutation device 21 is shown in FIG. 7 and details of it are shown in FIGS. 5 and 6.

To achieve a compact structural form with only slight radial dimensions, the stamped grid 23 is divided into an upper grid layer 231 (FIG. 5) and a lower grid layer 232 (FIG. 6), which are disposed parallel to one another with axial spacing (FIG. 7) and are electrically insulated from one another and held together by the insulator body 46 (FIG. 4). Each grid layer 231, 232 has a respective stamped track 27 and 28, extending on the outside approximately circularly, on one end of which a respective plug pin 132a and 132d is embodied. Each of the outer stamped tracks 27, 28 is provided with a respective clamp contact 29 and 30. The clamp contacts 29, 30 serve to contact an electrolyte capacitor 25 (FIGS. 2 and 7). In the stamped track 27 of the upper grid layer 231, through bores 31 for the lead through of fastening elements are disposed, spaced apart from one another, and with the sheathed stamped grid 23 is secured in the receiving chamber 20 of the motor housing 11. Two further plug pins 132b and 132c are embodied in the upper grid layer 231, oriented parallel to the plug pin 132a that is joined to the stamped track 27. On the inward-pointing end of the plug pins 132a, 132b and 132c, a respective connecting pin 32a, 32b and 32c is formed on, which after being bent out of the plane of the upper grid layer 231 is contacted on the printed circuit board 24. The contact points on the printed circuit board 24 are marked a, b, c in FIG. 2. Another contact point d on the printed circuit board 24 is connected to the stamped track 28 in the lower grid layer 232 via a connecting pin 32d.

For contacting the control terminals 221, 222 of the semiconductor switches 22, terminal lugs 231, 232 are embodied in each of the two grid layers 231, 232. The terminal lugs 33 in the upper grid layer 231 project radially from the stamped track 27, while the terminal lugs 34 in the lower grid layer 232 are provided, on their end remote from the contact point with the semiconductor switches 22, with insulation displacement contacts 351-356. The insulation displacement contacts 351-356 are radially offset from one another by equal circumferential angles and point toward the center of the lower grid layer 232. Corresponding to the six semiconductor switches 22 present, there are six terminal lugs 34, each with one insulation displacement contact 351-356. Three further insulation displacement contacts 361-363 protrude inward from the stamped track 28 and are bonded integrally to the stamped track 28, offset from one another by equal circumferential angles. All the insulation displacement contacts 35, 36 are embodied such that they can be bent out of the plane of the lower grid layer 232, the bending angle being approximately 90°.

For connecting the control electrodes 223 of the semiconductor switches 22 to the electronic control unit 22, connection pieces 37 are embodied in the upper grid layer 231; like the terminal lugs 33 and 34, they have a contact point for the semiconductor switches 22, in this case for attaching the control electrodes 223 of the semiconductor switches 22, and additionally, on the end remote therefrom, have radially inward-pointing connecting pins 38, which after being bent out of the plane of the upper grid layer 231 contact the printed circuit board 24 and there establish the corresponding connection points for the electronic control unit 22. The connecting pins 32 and 38 serve not only to make the electrical connection between the printed circuit board 24 and the stamped grid 23 but also to mechanically fix the printed circuit board 24 to the stamped grid 23, which can be done by a plugging operation, for instance.

The insulation displacement contacts 35, 36 in the upper grid layer 231 serve the purpose of solder-free contacting of the winding phases 151 of the stator winding 15, as shown by the electric circuit diagram of FIG. 2. Each of the insulation displacement contacts 361-363 connects one end of one of the three winding strands 151 of the stator winding 15 to the plug pin 132d, via the stamped track 28, while the insulation displacement contacts 351-356 connect the other ends of the winding phases 151, via the terminal lugs 33, to one control terminal 221 of the semiconductor switches 22 (or to the drain, in the case of MOSFETs). The contacting of the winding phases 151 is done upon insertion of the sheathed stamped grid 23 into the receiving chamber 20 in the motor housing 11. To that end, circular recesses 39, 40 (see FIGS. 1 and 3) are provided in the housing bottom 111; in the insertion position of the stamped grid 23 in the receiving chamber 20, they are aligned with the insulation displacement contacts 35, 36 protruding at right angles from the stamped grid 23. The recesses 39 are aligned with the insulation displacement contacts 351-356, and the recesses 40 are aligned with the insulation displacement contacts 361-363. In or behind each of these recesses in the stator body or lamination packet of the stator 14 is a contacting pocket 41 (FIG. 1), in which one winding end of a winding phase 151 is fixed in such a way that when the insulation displacement contacts 35, 36 plunge into the pockets 41, the insulation displacement contacts 35, 36 peel off the paint of the winding wire and establish a good connection between the winding wire and the stamped grid 23.

In the perspective plan view on the motor housing 11 with the housing cap 12 removed and with the stamped grid 23 and printed circuit board 24 not yet inserted, bearing cams 42 distributed over the circumference can be seen; the plastic-sheathed stamped grid 23 is placed as shown in FIG. 4, with its front side visible there, on these cams wedging pins 43 are provided on these bearing cams 42 and pass through the through bores 31 in the stamped grid 23. By wedging of these wedging cams 43, the stamped grid 23 with the printed circuit board 24 secured to it is retained in the receiving chamber 20.

The housing bottom 111 in the receiving chamber 20 is embodied as a cooling face and takes on the task of heat dissipation from the semiconductor switches 22. A concave indentation 44 (FIGS. 1 and 3) is also recessed into the housing bottom 111 and serves to allow the electrolyte capacitor 25 (FIGS. 2 and 7) to be placed in it without nonpositive engagement. For improved heat dissipation from the electrolyte capacitor 25, the concave indentation is coated with a heat-conducting paste.

The stamped grid 23 (FIG. 4), constructed as described above and embedded in the insulator body 46, also serves to retain the semiconductor switches 22. To that end, pockets 45 are formed into the insulator body 46, and the semiconductor switches 22 are inserted by positive engagement with their housing 224 into these pockets. The pockets 45 are each disposed between through bores 31 and are embodied with only a slight radial depth, so that a majority of the surface area of the housings 224 is in the open. Upon insertion of the stamped grid 23 into the receiving chamber 20 and once the stamped grid 23 is fastened in the receiving chamber 20, the stamped grid 23 presses these exposed housing faces of the semiconductor switches 22 against the cooling face of the housing bottom 111 by nonpositive engagement. An electrically insulating heat-conducting foil can also be placed between the housings 224 and the cooling face.

In FIG. 7, which is a plan view on the as yet unsheathed stamped grid 23 with its two grid layers 231 and 232, the disposition of the semiconductor switches 22 with housings 224, control terminals 221 and 222, and control terminals 223 is shown. The insulation displacement contacts 35 and 36 have not yet been bent out of the plane of two grid layers 231, 232. However, the plug pins 132 have already been bent out of the planes of the two grid layers 231, 232, specifically by approximately 90° in the opposite direction from the bending of the insulation displacement contacts 35, 36. Once the stamped grid 23 is fixed in the receiving chamber 20 and the housing cap 12 is placed on the motor housing 11, the plug pins 132, parallel to one another, dip into the plug housing 131 protruding axially from the housing cap 12, and the connection plug 13 for the EC motor is now complete. The negative potential of the direct-voltage system is applied to the plug pin 132a, and the positive potential is applied to the plug pin 132d. With the plug pin 132b, the signal line for the electronic control unit 22 is connected, and the plug pin 132c is intended as a reserve. On the inside, facing toward the receiving chamber 20, of the housing cap 12, a concave indentation 47 is also provided, which is located opposite the concave indentation 44 and likewise partly embraces the cylindrical jacket of the electrolyte capacitor 25, so that the electrolyte capacitor 25 is held without pressing force between the concave indentation 44 and the indentation 47 once the housing cap 12 is firmly fixed on the motor housing 11.

As the described structure of the stamped grid 23, embedded in the insulator body 46 and with the printed circuit board 24 attached to it, shows, all the power currents of the electronic components of the commutation device 21 are carried via the stamped grid 23, while only the weak control signals are carried in the conductor tracks 241 of the printed circuit board 24. In addition, the stamped grid 23 also takes on the task of retaining and positioning the semiconductor switches 22 as well as pressing the semiconductor switches by nonpositive engagement against the cooling face, thus assuring good dissipation of the heat produced in the semiconductor switches 22. The contacting of the stator winding 15 takes place automatically in the mounting operation, that is, upon insertion of the stamped grid 23 in its intended position in the receiving chamber 20 of the motor housing 11. There is no need for a thermal joining process for establishing the electrical contact between the stamped grid 23 and the stator winding 15.

The invention is not limited to the exemplary embodiment described above. For instance, the stator winding 15 may be embodied with an arbitrary number of phases, for instance with three phases or four phases. The number of semiconductor switches 22 should then be adapted to suit. In a three-phase stator winding 15 with an unoccupied star point, once again six semiconductor switches 22 should be provided, which are connected in a three-phase bridge circuit between the stamped tracks 27 and 28 of the upper and lower grid layers 231, 232 of the stamped grid 23. The drains 221 of three of the semiconductor switches 22, embodied as MOSFETs, and the sources 222 of the other semiconductor switches 22 are then each contacted, via three respective insulation displacement contacts 35, 36, to the beginnings of the windings of the three winding phases 151.

In the exemplary embodiment described, the stamped grid 23 is embodied in two layers, with an upper and a lower grid layer 231, 232, for reasons of space. However, the stamped grid 23 can also be embodied as a single layer.

1. An electronically commutated direct-current motor, having a stator (14), which has a stator winding (15) with a plurality of winding phases (151), having a plurality of semiconductor switches (22), each having one housing (224) with two power terminals (222) and one control terminal (223), for connecting the winding phases (151) to a direct voltage from the electrical system, having an electronic control unit (26) for consistent triggering of the semiconductor switches (22), having a motor housing (11) that carries the stator (14) and that receives both the semiconductor switches (22) and a printed circuit board (24) that carries the electronic control unit (26) and has conductor tracks (241), which printed circuit board, via its conductor tracks (241), connects the electronic control unit (26) to the semiconductor switches (22), and having a connection plug (13) for delivering the direct voltage from the electrical system, the connection plug having plug pins (132), characterized in that the plug pins (132) of the connection plug (13), the winding phases (151) of the stator winding (15), the power terminals (221, 222) of the semiconductor switches (22), and terminals (29, 30) of further power components are contacted on a stamped grid (23), with which an electrical connection with the printed circuit board (24) is established; and that the printed circuit board (24) is mechanically connected to the stamped grid (23), which is embedded in an insulator body (46).

2. The direct-current motor of claim 1, characterized in that for contacting the power terminals (221, 222) of the semiconductor switches (22), terminal lugs (33, 34) are embodied on the stamped grid (23).

3. The direct-current motor of claim 1 or 2, characterized in that for contacting the winding phases (151), insulation displacement contacts (35, 36) are embodied on the stamped grid in such a way that they establish electrical contact points with the associated winding phases (151) upon the insertion of the stamped grid (23) into the motor housing (11).

4. The direct-current motor of claim 3, characterized in that the insulation displacement contacts (35, 36) are bent out from the plane of the stamped grid (23).

5. The direct-current motor of one of claims 1-4, characterized in that the printed circuit board (24) is slipped onto the stamped grid (23).

6. The direct-current motor of one of claims 1-5, characterized in that the semiconductor switches (22) are retained on the stamped grid (23).

7. The direct-current motor of claim 6, characterized in that in the insulator body (46) of the stamped grid (23), pockets (45) are embodied, into which the semiconductor switches (22) with their housing (224) are inserted partway and by positive engagement.

8. The direct-current motor of one of claims 1-7, characterized in that the plug pins (132) of the connection plug (13) are embodied on the stamped grid (23) and are bent out of the plane of the stamped grid (23).

9. The direct-current motor of one of claims 1-8, characterized in that at least one pair of clamp contacts (29, 30), facing one another, for connection cords of power components, such as an electrolyte capacitor (25), are embodied on the stamped grid (23).

10. The direct-current motor of one of claims 4-9, characterized in that in the motor housing (11), a receiving chamber (20) is embodied that is closed off from the stator (14) by a housing bottom (111); that recesses (39, 40) are disposed in the housing bottom (111) in such a way that they are aligned with the insulation displacement contacts (35, 36) of the stamped grid (23) inserted into the receiving chamber (20); and that contacting pockets (41) open toward the receiving chamber (20) are provided on the recesses (39, 40), in each of which pockets one winding end of a winding phase (151) is disposed in such a way that it is contacted when the insulation displacement contact (35, 36) plunges into the associated contacting pocket (41).

11. The direct-current motor of claim 10, characterized in that through bores (31) for insertion therethrough of fastening means fixed in the receiving chamber (20) are provided in the stamped grid (23).

12. The direct-current motor of claim 10 or 11, characterized in that the receiving chamber (20) is closed off by a housing cap (12) secured to the motor housing (11).

13. The direct-current motor of claim 12, characterized in that the connection plug (13) is disposed in the housing cap (12) with plug pins (132) parallel to the axial direction of the motor housing (11).

14. The direct-current motor of one of claims 10-13, characterized in that the housing bottom (111) defining the receiving chamber (20) is embodied as a cooling face; that the pockets (45) in the insulator body (46) of the stamped grid are embodied such, and the stamped grid (23) is secured in the receiving chamber (20) such, that the housings (224), partly received in the pockets (45), of the semiconductor switches (22) rest by nonpositive engagement with one face region on the cooling face.

15. The direct-current motor of claim 14, characterized in that an electrically insulating heat-conducting foil is placed between the housings (224) of the semiconductor switches (24) and the cooling face.

16. The direct-current motor of one of claims 10-15, characterized in that a concave indentation (44) for nonpositive-engagement-free placement of an electrolyte capacitor (25), connected to the pair of clamp contacts (29, 30) of the stamped grid (23), is recessed into the housing bottom (111).

17. The direct-current motor of claim 16, characterized in that a concave indentation opposite the concave indentation (44) is recessed into the housing cap (12), and the electrolyte capacitor (25) additionally rests in it.

18. The direct-current motor of claim 16 or 17, characterized in that the concave indentation (44) is coated with a heat-conducting paste.

19. The direct-current motor of one of claims 4-18, characterized in that the stamped grid (23) has one upper and one lower, separate grid layer (231, 232), which are disposed in planes parallel to one another in spaced-apart fashion and are held together by the insulator body (46).

20. The direct-current motor of claim 19, characterized in that each grid layer (231, 232) has an approximately circularly encompassing stamped track (27, 28); and that the through bores (26) for the insertion therethrough of the fastening elements are disposed, spaced apart from one another, in at least one of the stamped tracks (27).

21. The direct-current motor of claim 19 or 20, characterized in that one of two plug pins (132a, 132d), serving to provide connection to the direct voltage from the electrical system, is embodied on each grid layer (231, 232).

22. The direct-current motor of one of claims 19-21, characterized in that one clamp contact (29, 30) of the pair of clamp contacts (29, 30) for the electrolyte capacitor (25) is embodied on each grid layer (231, 232).

23. The direct-current motor of one of claims 19-22, characterized in that at least one further plug pin (132b) of the connection plug (13) for connecting a signal line for the electronic control unit (26) is embodied in the upper grid layer (231) and is bent out of the plane of the stamped grid (23).

24. The direct-current motor of one of claims 19-23, characterized in that the terminal lugs (33, 34) for contacting the power terminals (221, 222) of the semiconductor switches (20) are distributed among the upper and lower grid layers (231, 232); that the terminal lugs (33) associated with the upper grid layer (231) extend inward away from the conductor track (27); and that connection pieces for the control grid (223) of the semiconductor switches (22) are provided in the upper grid layer (231).

25. The direct-current motor of claim 24, characterized in that connecting pins (38) for contacting the printed circuit board (24) are embodied on the connection pieces (37) and are bent out of the plane of the upper grid layer (281) of the stamped grid (23).

26. The direct-current motor of claim 25, characterized in that the printed circuit board (24) is disposed parallel to and spaced apart from the stamped grid (23) and is braced on the stamped grid (23) via the connecting pins (38) bent outward by approximately 90°.

27. The direct-current motor of one of claims 24-26, characterized in that the insulation displacement contacts (35, 36) are embodied in the lower grid layer (232) of the stamped grid (23); and that one group of insulation displacement contacts (35) is connected integrally to the terminal lugs (34) associated with the lower grid layer (232), and the other group of insulation displacement contacts (36) is connected integrally to the encompassing conductor track (28).
